(19) United States
(12) Patent Application Publication
(10) Pub. No.: US 2004/0267673 A1
(43) Pub. Date: Dec. 30, 2004

(54) Processing of credit card transactions using internet protocol

(76) Inventors: Claudio R. Ballard, Lloyd Harbor, NY (US); Keith DeLucia, Smithtown, NY (US)

Correspondence Address: ANDERSON, LEVINE & LINTEL L.L.P., 14785 PRESTON ROAD, SUITE 650, DALLAS, TX, 75254, US

(21) Appl. No.: 10/499,166

(22) PCT Filed: Sep. 15, 2003
(86) PCT No.: PCT/US03/31024

Related U.S. Application Data
(60) Provisional application No. 60/410,602, filed on Sep. 13, 2002.

(51) Int. Cl. G06F 17/60

(52) U.S. Cl. 705/77

(57) ABSTRACT

A system for processing credit card transactions is disclosed. Merchant locations include at least one Internet protocol (IP) capable credit card terminal, either connected directly to a wide area network such as the Internet, or connected to the Internet via a router. The IP capable credit card terminal forwards transaction information over the Internet, and biometric information regarding the presenting customer if desired and if available, which is processed by a credit card processing system. According to the embodiment of the invention, the credit card processing system is an IP credit card gateway processor, which formats the transaction information into a conventional format for processing by a credit card processor. According to another embodiment of the invention, the credit card processing system is a Direct IP credit card processor, which receives the IP transaction information, on biometrics if available, from the credit card terminal and which processes and communicated the information direction to the credit card issuer. Authorization of the transaction is then communicated by the credit card processing system over the Internet to the credit card terminal, so that the transaction is completed.

### BACKGROUND OF THE INVENTION

This invention is in the field of financial transactions and payment systems, and is more specifically directed to systems and methods for the processing of credit card payments.

Credit cards were first introduced in the US well in the 1950's. Up through the mid 1980's, credit card transaction processing was typically a highly manual, paper intensive procedure having no real-time interaction with the credit card companies. Prior to the advent of modern conventional credit card processing, if a merchant had to absolutely know that a credit card presented by a customer was good, for example as in payment of a large transaction amount such as a purchase in a jewelry store, the merchant would have to call the credit card issuer to obtain verbal authorization for the charge. Also in these early days, for transactions under a certain dollar amount, the merchant simply accepted the card as valid, hoping that the card he accepted was in fact good when settling up with the credit card companies. In an effort to stem losses and to shift the responsibility for losses to merchants, credit card companies regularly published printed hard copy lists of known closed, suspended, and stolen cards. Although archaic by today's standards, the process of looking up a credit card in a list did indeed help reduce fraud. However, significant expense was incurred by constantly publishing bad card lists, and human error associated with misreading or failing to read the lists still permitted massive fraud.

Additionally, government authorities began to shift the responsibility of fraud from the consumer and the merchant to the credit card companies. As a result, the credit card companies were forced to improve the process, or unilaterally absorb enormous fraud losses. The easiest way to eliminate fraud associated with using a cancelled, suspended, “maxed-out”, or stolen card, was to have a real-time interactive credit approval with the member issuer banks, which know precisely the amounts of available credit for each card in real-time. Merchants benefited from much faster sales processing by virtue of rapid credit card transactions at the cash register, translating into better customer satisfaction and improved profitability for the merchant, and eliminating human error associated with not carefully scrutinizing the presented card to make sure it was still valid. Even with these processing improvements, human cashier error continued to contribute to fraud, particularly from failure to carefully check that the customer presenting the card for payment was indeed the legitimate card holder.

During the 1980's and 1990's, various steps and procedures were gradually introduced by the industry in attempts to reduce losses from common fraud schemes. One then-common fraud involved the stealing of a credit card, and using it before a merchant could know that the credit was already entirely depleted or that the card itself was no longer valid. Merchant losses also stemmed from legitimate card users exceeding their own credit limits without the merchant knowing it, because there was no real-time interactive feedback with the card providers regarding remaining credit, and because merchants would simply not check the status of the card for small transactions. The first steps towards reducing these losses were to develop and deploy devices known as credit card terminals. These devices typically housed a modem and a simple special-purpose computer that was pre-programmed to automatically perform various functions with minimum human interaction. This pre-programming essentially consisted of encoding merchant information into the unit, along with appropriate phone numbers of credit card processors that the unit would call, based on the credit card type being swiped (VISA, MasterCard, AMEX, etc.) in the credit transaction. Referring to FIG. 1, conventional processing for real-time credit card verification was typically carried out as follows:

1. The merchant swipes the customer's credit card 2 through credit card terminal 4 and, when prompted, manually enters the transaction amount, and in some cases, the expiration date of credit card 2.

2. During the swipe, credit card terminal 4 reads the magnetic stripe on the back of credit card 2, and accepts the manually entered information described in step 1.

3. Credit card terminal 4 decodes information from the magnetic stripe, that among other things includes the credit card type (VISA, MasterCard, AMEX, etc.), credit card account number, expiration date, and other control information designed to reasonably assure that the swiped credit card 2 is legitimate.

4. Based upon the credit card type, credit card terminal 4 automatically selects and dials the appropriate credit card processor telephone number stored in its memory, beginning the transaction process.

5. Once the credit card processor 6 answers the call, the credit card terminal initiates a credit authorization session by sending, over telephone line 5, a data packet that includes the merchant's terminal identification, credit card information, transaction amount, and other relevant information decoded from the magnetic strip on credit card 2, or manually entered by the merchant.

6. Credit card processor 6 accepts the incoming transaction information, performs various data validation checks on the just received information, and formats the transaction so that it is compatible with the appropriate credit card issuer (VISA, MasterCard, AMEX, etc.).

7. Credit card processor 6 then routes the transaction to the appropriate credit card issuer datacenter 8 (VISA, MasterCard, AMEX, etc.) via one or more high speed data communications facilities 7, such as frame relay or other such high speed means.

8. Once the transaction arrives at the credit card datacenter 8 (VISA, MasterCard, AMEX, etc.), it is routed, based upon the incoming transaction information, to the appropriate issuing member bank (e.g., Chase, Citibank, Fleet, etc.), generally also over high-speed communications facility 9.

9. Once the transaction arrives at the appropriate issuing bank datacenter 10, the credit card account number is retrieved from the bank's database to determine various aspects of the credit account status and how much available credit is remaining.

10. Assuming there are no problems with the credit account status, and that the remaining credit is sufficient to accept the presented transaction amount, an approval code is generated and rerouted back to the credit card datacenter 8 that originated the credit transaction. In turn, the approval code is rerouted by the credit card datacenter 8 back to the originating credit card processor 6, which in turns reroutes the approval code to the awaiting credit card terminal 4 at the originating merchant's location. The credit card terminal 4 displays the approval code, and will typically then print out a receipt for the merchant to present to the customer for signature. In addition, the credit card issuing bank 10 may also credit the merchant's bank account at the merchant's bank 12, in the amount of the transaction less processing fees, upon approval of the credit card transaction.

This entire process, start to finish, is usually accomplished in between 5 and 20 seconds, largely depending on number of credit card transactions being processed by the credit card processor 6, credit card issuer datacenter 8, and issuing bank datacenter 10 at any given point in time.

Although the aforementioned automation made significant inroads in reducing fraud, nevertheless, fraud continues to remain as a major issue to this day. Consequently, since fraud was not eliminated and since there continues to be no cost-effective means of eliminating fraud, the credit issuers have since decided to charge merchants for the cost of fraud, and merchants have accepted these charges as a cost of doing business. Credit card company analysts have determined a set of conditions that can predict, with a high degree of certainty, the risk associated with any given credit card transaction. For example, on occasion, a legitimate credit card user with sufficient available credit may present their card as payment for a purchase, but the merchant may discover that the presented card will not work when swiped through the credit terminal. This can result from any one of several causes that include, among others, that the card is physically damaged, that the card has been exposed to a strong magnetic field, that the magnetic stripe on the back of the card is partially worn off due to use, and that the credit card terminal itself is not functioning properly. However, the merchant must either obtain an approval code from the credit card company when accepting credit cards for payment, or bear the full liability of loss if the charge is not accepted without an approval code. Therefore, because the merchant certainly does not wish to lose the sale in the event of a credit terminal read failure from any cause, the credit card companies devised a means of still enabling the transaction—namely by permitting the merchant to manually enter the credit card information into the terminal via a numeric keypad.

However, manual entry of credit card information results in higher cost to the merchant. In general, credit card transaction fees paid by merchants are broken down into two basic components, 1) the interchange rate (also known as the discount rate)—which is a percentage of the transaction value, typically ranging from 1.9% to several percent of the transaction value, and 2) the transaction fee—usually around $0.20. In each instance that the merchant manually enters credit card information, the merchant is charged a higher discount rate for the transaction, meaning that if they normally pay 2% on a transaction, the rate could easily more than double. From the credit card company point of view, the rate hike is based on the assumption that, if the card is unreadable by the terminal, the possibility may also exist that a credit card is in fact not physically present, and that the merchant has unlawfully obtained the credit card information (namely the credit card account number and expiration date) and is attempting to execute a fraudulent transaction. Such a circumstance, known as “Credit Card Not Present”, entails an appropriately higher discount rate and other possible surcharges imposed by the credit card companies and/or processors.

During the mid 1990's, the rapid growth of the Internet quickly led to the idea of purchasing items “on-line” merchants, such as Amazon.com, that may not have a physical “brick and mortar” retail store, but instead operate out of a warehouse. Although the Internet presented an entirely new and low cost way of doing business for merchants of all types selling to consumers and general business markets, it also presented a whole new suite of problems, particularly from a payment standpoint. Since the legacy credit card industry was not necessarily interested in the Internet at the time, especially because it was such a miniscule market, the industry had avoided the development of any sort of payment technology suitable to Internet-originated credit card transactions. Consequently, it was left to a small group of technology companies to develop a process that would transparently mesh with the credit card industry without requiring it to change—the Internet would somehow adapt to work within the existing credit card industry infrastructure.

The basic conventional process for Internet transaction processing is rather similar to the “brick and mortar” approach of FIG. 1, but with two key differences:

1. Because there is no credit card terminal (instead the transaction is initiated on a person's PC by entering a credit card number, card holder name, expiration date, and optionally other information from the back of the credit card), by definition there is no credit card present—meaning that the potential for fraud is large simply because the on-line customer may be an imposter having unlawfully acquired all the relevant information from a physical credit card or from a list of credit information that may have been acquired from a merchant's on-line transaction processing database. And as it turns out, the Internet indeed currently represents the largest area of fraud growth in connection with credit card processing.

2. Because the credit transaction information is transported over the Internet, the entire process and data stream that constitutes a credit card transaction originating on the Internet is inherently different in format and process than the traditional “brick-and-mortar” merchant dialup methodology found in the legacy credit card processing environment—thus rendering the entire Internet credit card processing scheme incompatible with the existing legacy technology dialup architecture supported by the credit card industry to this day.

The solution developed by the Internet community, was to deploy an intermediate step, known in the industry as a “gateway” capability. An example of the parties and communications involved in this conventional credit card transaction processing via a gateway is illustrated in FIG. 2, in which the same entities as present in the example of FIG. 1 are referred to by the same reference numerals. According to this approach, gateway 14 is essentially an additional “electronic middle man” that intercepts the inbound Internet based credit card transaction originated from an online merchant shopping cart 15 or a PC user's own computer 17, reformats it according to predefined credit card processor standards and then forwards the now properly formatted transaction to the existing legacy credit card processor 6 that then hands off the transactions to the credit card issuer 8, and so on, as is done for traditional credit card terminal transactions described above in FIG. 1. Since these Internet transactions are not done in the physical presence of the merchant, they are inherently treated as “Credit Card Not Present” transactions, and therefore carry an accordingly higher discount rate and overall processing cost. Interestingly, even though the Internet transactions originated via a PC 17 are not considered as “Credit Card Present”, if a merchant were to use, in his store, an Internet-enabled and certified Point-of-Sale (POS) system, such as those available from Micros, those credit card transactions would enjoy a discount rate comparable to that of brick and mortar “Credit Card Present” transactions because a swipe device is on the POS system, and because the entire system is treated as a certified environment designed to ensure that a credit card was indeed physically present and swiped when initiating the transaction.

Ironically, despite the higher transaction fees charged for Internet-based transactions as shown in FIG. 2, the Internet has served to highlight that traditional credit card transaction processing is archaic and is based upon a legacy infrastructure that is costly to operate and maintain, and that significantly lower costs could be realized if these barriers were eliminated. In this regard, U.S. Pat. No. 6,032,137 and U.S. Pat. No. 5,910,988, both commonly owned with this application and incorporated herein by this reference, disclose the concept of handling credit, debit, and checking transactions in a “brick and mortar” environment over a wide area network, such as the Internet.

In recent years, it has been observed, in connection with this invention, that credit card processors have not been willing to use full Internet protocol (IP) for credit card transactions in the typical “brick and mortar” point-of-sale (POS) environment, because of their investment in existing dialup infrastructure that would be rendered obsolete upon deployment of IP based credit card terminals.

By way of further background, U.S. Pat. No. 5,351,286 describes a method and system for implementing billing and payment over an Integrated Services Digital Network (ISDN) broadband network.

### BRIEF SUMMARY OF THE INVENTION

It is therefore an object of this invention to provide an Internet-based financial payment system that can greatly reduce the costs to merchants and credit card processors.

It is a further object of this invention to provide such a system that can take advantage of higher-speed communications protocols and technology in effecting payment transactions.

It is a further object of this invention to provide such a system that can qualify Internet protocol credit card terminals for “Credit Card Present” status, thus reducing the credit card processing costs for merchants.

It is a further object of this invention to provide such a system in which a credit card transaction can go directly from an on-line merchant's customer shopping cart directly to the credit card processor, bypassing the need for a gateway intermediary in the Internet environment.

Other objects and advantages of this invention will be apparent to those of ordinary skill in the art having reference to the following specification together with its drawings.

The present invention may be implemented by way of an Internet Protocol (IP) based credit card payment processing system. Either by way of an IP credit card gateway that processes credit card transaction information received over the Internet by way of an IP connection to a credit card terminal, or by way of a Direct IP credit card processor, transaction information such as credit card transactions, debit card transactions, and checks, are transmitted over Internet Protocol (IP) from a IP transaction unit. In the case of the Direct IP credit card payment processor, the IP-based payment transactions are accepted in their IP form, and the Direct IP credit card payment processor also performs the traditional functions of the credit card processor, namely performing data integrity checks on the received IP information, formatting the transaction to a form compatible with the credit card (or other payment) issuing facility, routing the transaction to the appropriate credit card issuer or other payment datacenter (VISA, MasterCard, AMEX, etc.), receiving transaction approval codes from the datacenter and forwarding the transaction approval code to the awaiting IP transaction unit, for example at the originating merchant's location.

### BRIEF DESCRIPTION OF THE SEVERAL VIEWS OF THE DRAWING

FIG. 1 is a block diagram illustrating the system and processing method of conventional credit card purchase transactions.

FIG. 2 is a block diagram illustrating the system and processing method of conventional credit card purchase transactions over the Internet.

FIG. 3 is a block diagram illustrating the system and processing method of Internet-Protocol-based credit card purchase transactions according to a first preferred embodiment of the invention.

FIG. 4 is a block diagram illustrating the system and processing method of Internet-Protocol payment transactions according to a second preferred embodiment of the invention.

### DETAILED DESCRIPTION OF THE INVENTION

The present invention will be described in connection with the example of payment transactions using a credit card as the payment system device presented by the consumer. It is to be understood, however, that this description is by way of example only, especially considering that this invention is contemplated to also be useful in connection with other payment systems, including debit cards, checks, debit or credit transactions against an existing bank account, wire transfer, and the like.

In connection with the present invention, it is contemplated that the overall payment system within which this embodiment is implemented may correspond to those described in U.S. Pat. No. 6,032,137 and in U.S. Pat. No. 5,910,988, both commonly owned with this application and incorporated herein by this reference. It is further contemplated that the system and methodology according to this embodiment of the invention may alternatively be adopted in other payment and data processing environments.

According to this invention, various consumer terminals may be used in connection with this invention. For example, a merchant location may have a credit card terminal that receives a conventional credit card with magnetic stripe containing the account and issuer information, by way of which the consumer may pay for a particular transaction. As known in the art, this credit card terminal may also receive a debit card, or other payment system card such as a state welfare benefits card. According to this embodiment of the invention, the credit card terminal is an Internet Protocol (IP) device, in that it has an IP address and has access to a wide area network such as the Internet, either directly or through a router or other network arrangement. The merchant location may also receive credit information by way of a wireless-network device, such as a wireless credit card reader; the wireless-network device is in wireless communication with a router, hub, server, or other IP device, which has access to a wide area network, such as the Internet, or in communication with a wireless communications service provider, which in turn accesses the WAN or Internet. The wireless-network device may be a handheld credit card reader, or alternatively may be a device that itself receives payment information by way of a wireless communication with the consumer, for example as embodied in conventional transponders used to pay traffic tolls from a moving automobile, or a payment transponder such as the SPEEDPASS device available through Exxon Mobil Corporation. Further in the alternative, it is contemplated that the payment terminal may also be capable of reading paper checks or other payment documents, and of forwarding transaction information from the scanned documents.

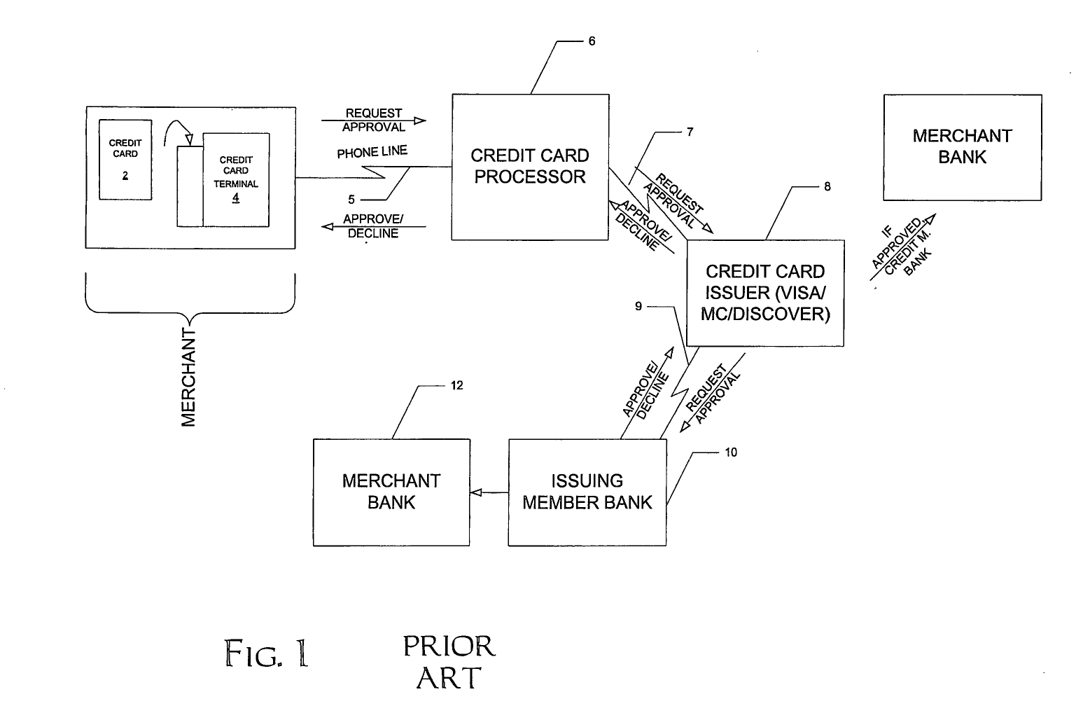

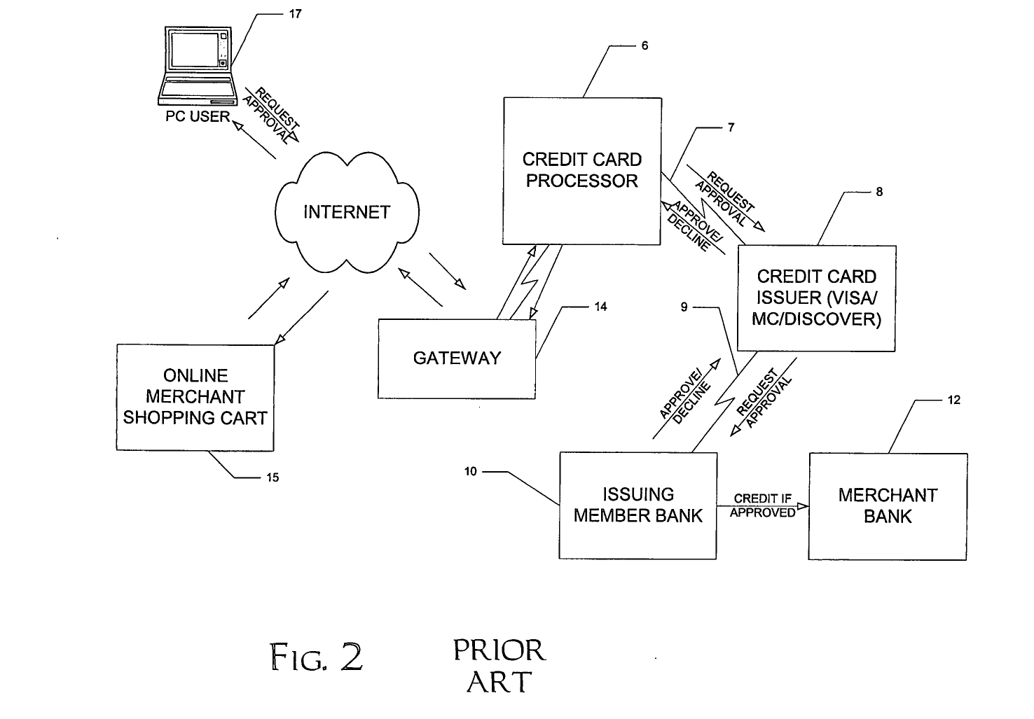

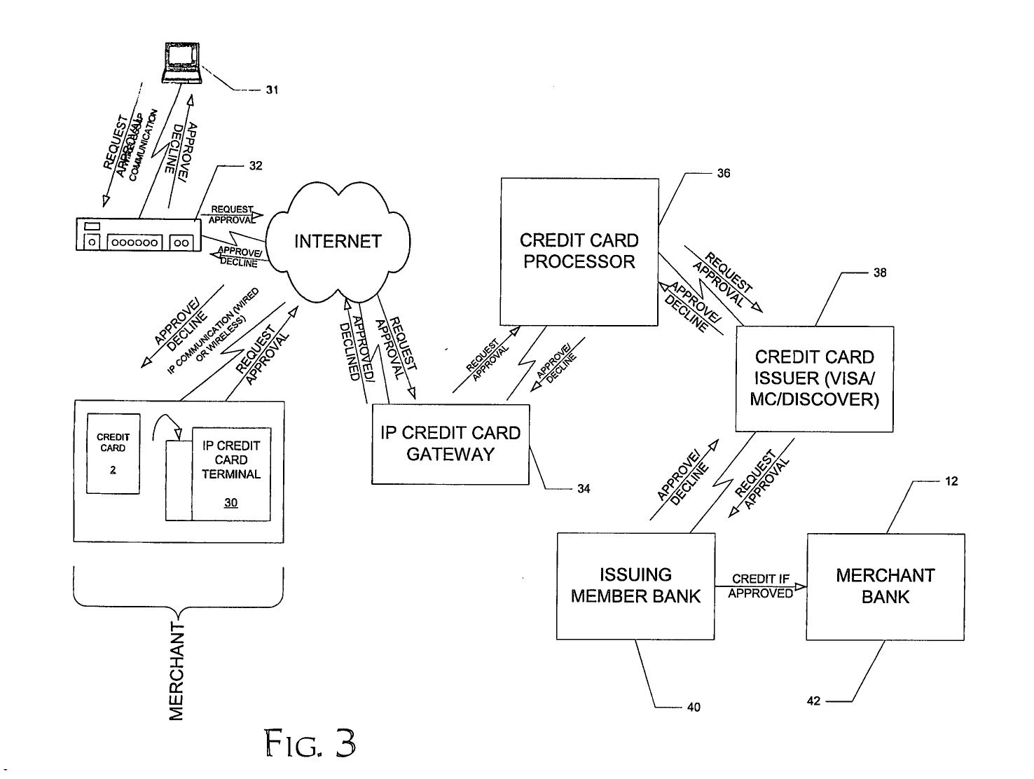

Referring now to FIG. 3, an arrangement of parties and transactions using IP-based credit card terminals, according to a first preferred embodiment of the invention, will now be described. As shown in FIG. 3, the merchant location utilizes an IF-enabled credit card terminal 30 that has an Internet Protocol (IP) address, and that communicates its transaction and account information to IP credit card gateway 34 over a wide area network, such as the Internet. In this example, IP credit card terminal 30 communicates this information directly to the Internet, by way of a wired or wireless IP communication link, preferably a high-speed always-on link such as digital subscriber line (DSL), cable modem, ISDN line, or the like. In addition or in the alternative, wireless payment device 31, such as a merchant handheld or wireless network purchasing unit, receives transaction and account information and communicates this to IP credit card gateway 34 over the Internet, by way of router 32 that is contemplated to be present at or near the merchant location. Router 32 communicates to the Internet over an IP communication link, preferably a high-speed link as mentioned above. Further in the alternative, IP-enabled credit card terminal 30 may also be connected to the Internet through router 32, if desired. In contrast to conventional approaches, such as shown in FIG. 1, the merchant credit card terminals 30, 31 no longer use a dial-up connection to a credit card processor, but rather communicate the same, conventional, credit card and transaction information over the Internet to IP credit card gateway 34. In this embodiment of the invention, similarly as in the conventional arrangement of FIG. 2, IP credit card gateway 34 accepts the Internet based credit card transactions, reformats them according to credit card processor standards and then transmits the correctly formatted transactions to existing credit card processors 36 who then hand off the transactions to credit card issuer companies 38, and so on, to carry out the processes of requesting approval of the credit card transaction and of reporting that the transaction has been approved or declined, as the case may be.

In this embodiment of the invention, the IP credit card reader 30, or IP router 32 that is in wireless communication with a wireless payment device 31, accesses the Internet. To effect this connection, the payment terminal 30, 31 preferably has its own dedicated Ethernet connection that is connected to any wide area network architecture, either directly or by way of router 32, thus enabling it to connect directly over IP to IP Credit Card gateway 34 as shown in FIG. 3. IP credit card gateway 34 serves as an intermediary in the transaction by intercepting the inbound (or upstream) Internet credit card transaction and transforming its format in accordance with the requirements of credit card processor 36. It is contemplated that this connection between the payment terminals 30, 31 and the IP credit card gateway 34 and, eventually credit card processor 36, enables payment terminal 30, 31, namely this new technology IP credit card terminal, to qualify for “Credit Card Present” status by VISA and MasterCard.

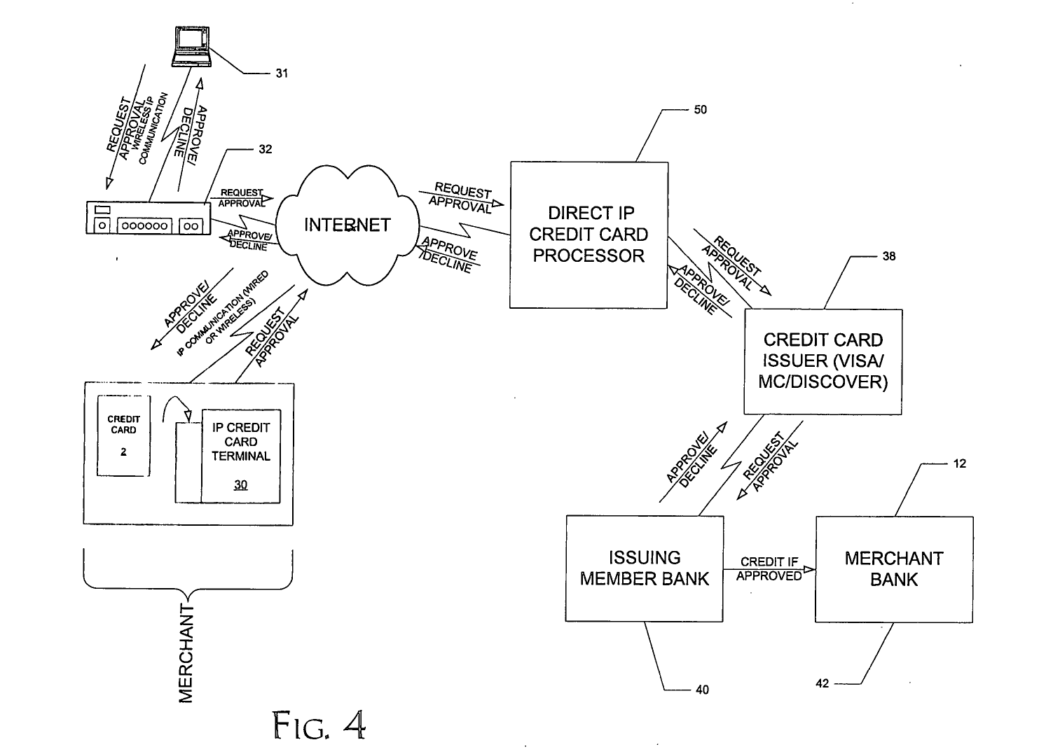

FIG. 4 illustrates another preferred embodiment of the invention. In this embodiment of the invention, the IP credit card reader and terminal 30, or IP router 32 that is in wireless communication with a wireless payment device 31, accesses the Internet and communicates the payment information to a Direct IP credit card processor 50 constructed and operating according to this invention. To effect this connection, the payment terminal preferably has its own dedicated Ethernet connection that is connected, either directly by a wired or wireless IP communication link or via router 32 and its IP communication link, to any wide area network architecture, thus enabling it to connect directly over IP to Direct IP credit card processor 50 as shown in FIG. 4. No gateway intermediary is involved in the transaction, according to this embodiment of the invention. It is contemplated that this direct connection between payment terminals 30, 31 and the Direct IP credit card processor 50 enables payment terminals 30, 31, namely this new technology IP credit card terminal, to qualify for “Credit Card Present” status by VISA and MasterCard.

In addition, in either of the preferred embodiments of the invention as shown in FIGS. 3 and 4, it is contemplated that payment terminals 30, 31 may also have biometric measurement capability that operates in communication with the IP credit card gateway 34 (FIG. 3) or Direct IP credit card processor 50 (FIG. 4) to verify the identity of the purchaser. For example, payment terminals 30, 31 may have a device for acquiring biometric information, such as a fingerprint or iris scan, from the individual presenting the payment item (credit card, debit card, check and the like) and for communicating this biometric information to the IP credit card gateway 34 or Direct IP credit card processor 50, as the case may be. In this implementation, the IP credit card gateway 34 or Direct IP credit card processor 50 can match the biometric measurement with known credit holders in its data repository, for example, either to match the credit holder with the credit card or other payment information presented by the purchaser, or alternatively to activate a set of accounts associated with that purchaser. This additional capability of the IP credit card gateway 34 or Direct IP credit card processor 50, which may be referred to as “Credit Holder Present” capability, further improves the accuracy of the payment system and further reduces the possibility of fraud, while also improving customer and merchant convenience.

It is further contemplated that this invention will spur the rapid adoption of an entirely new designation of credit card transaction, namely “Credit Holder Present”, as the “holy grail” of the credit card transaction processing industry, providing absolute certainty of knowing the legitimate credit card holder is himself or herself attempting a given credit card transaction, for example when the biometric measurements at the payment terminal match the stored biometric information. This biometric matching eliminates all fraud associated with an imposter having misappropriated a legitimate cardholder's physical credit card and/or credit account information. It is further contemplated that this designation of “Credit Holder Present”, resulting from the biometric measuring and matching, can also be used for other payment systems, including debit cards, checks, and the like; as such, this designation may be more generically referred to as “Account Holder Present”.

It is further contemplated that this invention is also applicable to an eCommerce scenario over the World Wide Web, similar to the conventional system illustrated in FIG. 2 and variations thereof, particularly by implementing a Direct IP credit card processor 50 in the manner illustrated in FIG. 4. In this scenario, a credit card transaction would go directly from the on-line merchant's customer “shopping cart” directly to the Direct IP credit card processor 50 as shown in FIG. 4, bypassing the need for a gateway intermediary in this Internet commerce environment as well.

The specific information communicated over the Internet by the payment terminal will depend upon the type of transaction being processed. In most cases, for credit card transactions, this information is contemplated to include credit card type (VISA, MasterCard, AMEX, etc.), credit card account number and expiration date, transaction amount, and identification information regarding the merchant that is submitting the transaction. For debit card and other payment systems, the transmitted information will vary from this accordingly, but is contemplated in each case to indicate identification information regarding the purchaser and his or her accounts, the merchant and its accounts, the transaction amount, and information regarding the type or class of payment system.

According to the second preferred embodiment of the invention described in FIG. 4, the Direct IP credit card processor 50 receives and accepts the information concerning the IP-based payment transaction, in its IP form as transmitted over the Internet from the merchant, and performs those processes appropriate to the processor of the payment system. It is contemplated that the Direct IP Credit Card Processor may be constructed as a conventional computer system of appropriate computational capacity to handle the transactions described herein, at the desired transaction volume. It is further contemplated that those skilled in the art having reference to this specification will be readily able, without undue experimentation, to program such a computer system to carry out the processes described in this specification. For credit card transactions, these processes performed by the Direct IP credit card processor 50 correspond to those performed by conventional credit card processors, and include the performing of data integrity checks on the received IP information, formatting the transaction to a form compatible with the credit card (or other payment) issuing facility, and routing the transaction to the appropriate credit card issuer or other payment datacenter 38 (VISA, MasterCard, AMEX, etc.).

It is further contemplated that either of the preferred embodiments of the invention described herein may also be capable of handling check-based transactions. In this event, the IP credit card gateway 34 and Direct IP credit card processor 50 are contemplated to have additional capabilities, including check truncation, verification, guarantee services, in addition to the usual check processing operations. It is contemplated that other transactions may additionally and optionally be supported by the IP credit card gateway 34 or Direct IP credit card processor 50, including gift and loyalty program management. It is further contemplated that mail order and telephone order processing may be performed by the IP credit card gateway 34 or Direct IP credit card processor 50, on behalf of the merchant, in addition to the processing of the payment system itself.

In each of the preferred embodiments of the invention shown in FIGS. 3 and 4, credit card issuer 38 then performs its usual operations on a transaction received from a credit card processor 36, including the routing of the incoming transaction to the appropriate issuing member bank (e.g., Chase, Citibank, Fleet, etc.), based upon the transaction information. Once the transaction arrives at the appropriate issuing bank datacenter 40, the credit card account number is retrieved from the bank's database to determine various aspects of the credit account status and how much available credit is remaining. Assuming there are no problems with the credit account status, and that the remaining credit is sufficient to accept the presented transaction amount, an approval code is generated and rerouted back to the credit card issuer datacenter that originated the credit transaction. The credit card issuer than communicates the approval of the transaction to IP credit card gateway 34 or to Direct IP credit card processor 50, as the case may be.

In response to receiving transaction approval codes from the credit card issuer 38, IP credit card gateway 34 (in the embodiment of FIG. 3) or Direct IP credit card processor 50 (in the embodiment of FIG. 4) forwards the transaction approval code to the awaiting IP transaction unit (i.e., IP credit card terminal 30, or wireless payment device 31) at the originating merchant's location. The corresponding terminal 30, 31 will then display or print the appropriate approval, and generate the necessary signature form (electronic or on paper) for signing by the consumer in the manner necessary for the transaction and the payment system. The issuing member bank 40 then communicates with the merchant's bank 42, to credit the merchant's account with the proceeds of the transaction, less processing fees, in the usual course. The transaction is then complete.

If desired and available, the transaction, signature data, and other information associated with the transaction may then be communicated to a data repository for linkage, storage, and other processing for example as described in U.S. Pat. No. 6,032,137 and in U.S. Pat. No. 5,910,988, both commonly owned with this application and incorporated herein by this reference.

This invention is contemplated to be of great value in the payment system industry because it enables a rapid and widespread shift by merchants to credit card processors that were not previously dependent on dialup infrastructure but instead use IP based technology. Due mostly to lower operating costs associated with an IP architecture, the implementation of a direct IP processor according to this invention, which handles only IP based credit card transactions, would permit a reduction in transaction fees to the merchants.

Specifically, credit card transaction costs to merchants are based upon two basic elements: 1) cost of a telephone line, typically $40 per month, that depending upon the number of credit card terminals in a given retail establishment, could reach into the hundreds of dollars per month due to needing a dedicated telephone line per credit card terminal, and 2) the credit transaction fees charged by the processor to handle each transaction. For example, if a merchant such as a large restaurant had ten credit card terminals, which is not uncommon in a large metropolitan city, this merchant would be paying $400 per month just for telephone lines to accommodate their terminals. In contrast, by using a direct IP credit card processor that utilizes an IP architecture, according to this invention, a single DSL, ISDN, or cable modem line would accommodate ten or many dozens of IP enable credit card terminals, at a cost of only $45 per month, thus saving, in this example, $355 per month. Additionally, since the infrastructure is now IP based such that an IP based processor can be set up at a small fraction of the cost of a more traditional dial-up based processor, it is contemplated that the transaction fee also can be significantly reduced, perhaps to on the order of one-half the present fee—e.g., from $0.20 to $0.10—while still enabling the credit card processor to reap higher profits even from this reduced transaction fee, relative to the older architecture processors. For example, conventional dial-up based processors that charge on the order of $0.20 per transaction may have a cost of about $0.13 per transactions, while an IP-based processor's costs, according to this invention, is contemplated to be as low as less than $0.01, increasing the profit even if the transaction fee is reduced by one-half to $0.10 transaction fee. According to this invention, a higher profit margin for transaction fees can be achieved by this invention, relative to older architecture processors.

According to this invention, a system according to the preferred embodiment of this invention is capable of handling credit card transactions over a wide area network, such as the Internet, from either a brick and mortar retail environment or from Web based eCommerce, without the need for a gateway processor as an extra middleman. The connectivity required in a brick and mortar environment is contemplated to be DSL, Cable Modem, ISDN or any other form of digital telecommunication—including wireless based technologies. It is contemplated that, in a retail environment, the payment terminal will have its own dedicated Ethernet connection that is connected to any wide area network architecture thus enabling it to connect directly over IP to the processor which would then qualify this new technology IP credit card terminal for “Credit Card Present” status by VISA and MasterCard. In addition, the same terminal could also connect via a wireless technology. In an eCommerce scenario over the Web, a credit card transaction would go directly from the on-line merchant's customer shopping cart directly to the processor, bypassing the need for a gateway intermediary in the Internet environment as well.

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention.

What is claimed is:

1. A system for processing payment transactions, comprising:
at a merchant location, at least one payment terminal having Internet Protocol capability, coupled to a wide area network; and
a payment processor, coupled to the wide area network, for receiving transaction information from the at least one payment terminal, the transaction information including at least a payment type, an account number, a transaction amount, and merchant identification, for processing this transaction information and forwarding it to an issuing institution, and for communicating an authorization to the at least one payment terminal responsive to signals received from the payment issuer in response to the forwarded transaction amount.

2. The system of claim 1, wherein the at least one payment terminal is a credit card terminal;
wherein the transaction information includes at least a credit card type, a credit card account number;
wherein the payment processor comprises an IP credit card gateway processor for reformatting the received transaction information into a format corresponding to credit card processor standards;
wherein the issuing institution is one of a plurality of credit card issuers;
and wherein the system further comprises:
a credit card processor for receiving the reformatted transaction information from the IP credit card gateway processor and for forwarding the transaction information to a selected one of the plurality of credit card issuers.

3. The system of claim 2, wherein the at least one credit card terminal comprises:
a credit card reader; and
means for measuring a biometric;
wherein the transaction information received by the Direct IP credit card processor further comprises biometric measurements from the at least one credit card terminal;
and wherein the IP credit card gateway processor is also for matching the biometric measurements with stored biometric data, to determine whether the biometric measurements match an identity associated with the credit card account number.

4. The system of claim 1, wherein the at least one payment terminal is a credit card terminal;
wherein the transaction information includes at least a credit card type, a credit card account number;
wherein the payment processor comprises a Direct IP credit card processor for receiving the transaction information from the one credit card terminal, for performing of data integrity checks on the received transaction information, and for routing the transaction information to a selected one of a plurality of credit card issuers.

5. The system of claim 4, wherein the at least one credit card terminal comprises:
a credit card reader; and
means for measuring a biometric;
wherein the transaction information received by the Direct IP credit card processor further comprises biometric measurements from the at least one credit card terminal.

6. The system of claim 5, wherein the Direct IP credit card processor is also for matching the biometric measurements with stored biometric data, to determine whether the biometric measurements match an identity associated with the credit card account number.

7. The system of claim 1, wherein the transaction information comprises checking account information, comprising a checking account number and bank identification;
and wherein the credit card processor is also for performing check truncation, verification, and check guarantee processing.

8. The system of claim 1, wherein the at least one credit card terminal is directly coupled to the wide area network.

9. The system of claim 1, further comprising:
a router, for coupling the at least one credit card terminal to the wide area network.

10. The system of claim 1, wherein the wide area network is the Internet.

11. The system of claim 1, wherein the at least one payment terminal comprises:
a payment item reader; and
means for measuring a biometric;
wherein the transaction information received by the payment processor further comprises biometric measurements from the at least one payment terminal;
wherein the payment processor is also for matching the biometric measurements with stored biometric data, to determine whether the biometric measurements match an identity associated with the account number;
and wherein the payment processor is also for indicating the transaction corresponding to the transaction information and matched biometric measurements as having an “account holder present”.

12. The system of claim 11, wherein the payment item reader is a credit card reader.

13. The system of claim 11, wherein the payment item reader is a debit card reader.

14. The system of claim 11, wherein the payment item reader is a check reader.
